(19) United States
(12) Patent Application Publication
(10) Pub. No.: US 2010/0309463 A1
(43) Pub. Date: Dec. 9, 2010

(54) SPECULAR INTEGRATING TUBE FOR SCATTERED-LIGHT SPECTROSCOPY

(76) Inventors: Robert Lucke, Springfield, VA (US); Jacob Grun, Silver Spring, MD (US); Charles K. Manka, Alexandria, VA (US); Sergei Nikitin, Springfield, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/534,244

(22) Filed: Aug. 3, 2009

Related U.S. Application Data
(60) Provisional application No. 61/184,047, filed on Jun. 4, 2009.

(51) Int. Cl. G01J 3/44; G01N 21/01

(52) U.S. Cl. 356/301; 356/244

(57) ABSTRACT

A scattered-light spectroscopy system for collecting light scattered from a sample, e.g. Raman-scattered light, to produce a spectrum of the sample, includes a cylindrical cell for holding the sample that is transparent and coated on either its inside surface or outside surface with a reflective coating, e.g. aluminum. The reflective coating has an opening for aligning with an aperture in a spectrometer for receiving the sample-scattered light. Light from a source such as a laser illuminates the sample to produce a scattered light having a first part received directly at the opening and a second part reflected by the reflective coating one or more times prior to arrival at the opening, thereby adding to the total scattered light entering the aperture of the spectrometer to improve its collection efficiency.

### TECHNICAL FIELD

The invention is directed to a scattered light spectroscopy system, and in particular, to a Raman-scattered spectroscopy system that includes a sample cell having a reflecting surface for improving the scattered light collection efficiency.

### BACKGROUND OF THE INVENTION

Scattered-light spectroscopy refers primarily to spectroscopy of laser-induced Raman scattering—e.g. as described in U.S. Pat. No. 7,436,510, Grun et al., entitled “Method and Apparatus for Identifying a Substance Using a Spectral Library Database”, issued Oct. 14, 2008, and incorporated herein by reference—but more generally to spectroscopy of any scattered or fluorescent light that is emitted isotropically, or nearly so. Scattered-light spectroscopy is finding increased application to the problem of detecting and identifying small quantities of materials, such as explosives and biological agents. One of the uses of scattered-light spectroscopy is to detect small quantities of a material dissolved in a liquid. This is done by putting the liquid in a small glass cell, sending a laser beam through the cell to stimulate scattering, then illuminating the slit of a spectrometer with the scattered light. If the concentration of material in the liquid is very dilute, it becomes very difficult to send enough light into the spectrometer to make detection possible, or it takes a long integration time to detect the material. The samples of these materials are often available only in extremely small quantities and it becomes important to collect light scattered from them as efficiently as possible.

Heretofore, the liquid sample containing the material to be identified has been placed in a glass tube of square or cylindrical cross section and the light collected by a nearby spectrometer slit or, more commonly, by an optical system that transfers the light to the spectrometer slit. The limitation of this method is that only light that leaves the illuminated region in the direction of the slit or collection system can enter the spectrometer and contribute to the measured signal. Light that leaves the illuminated region in other directions is lost.

It would therefore be desirable to significantly increase the collection efficiency for scattered light, thereby allowing detection and identification of smaller samples of a material than is otherwise possible, or to allow such detection in a shorter time.

### BRIEF SUMMARY OF THE INVENTION

A scattered-light spectroscopy system for collecting light scattered from a sample, e.g. Raman-scattered light, to produce a spectrum of the sample, includes a cylindrical cell for holding the sample that is transparent and coated on either its inside surface or outside surface with a reflective coating, e.g. aluminum. The reflective coating has an opening for aligning with an aperture in a spectrometer for receiving the sample-scattered light. Light from a source such as a laser illuminates the sample to produce a scattered light having a first part received directly at the opening and a second part reflected by the reflective coating one or more times prior to arrival at the opening, thereby adding to the total scattered light entering the aperture of the spectrometer to improve its collection efficiency.

In one embodiment, the spectrometer is positioned close to the cell with its aperture proximate to and aligned with the opening, without intervening light collections optics components. In other embodiments, the spectrometer and cell are spaced apart with light collections optics means, e.g. a lens or a primary mirror-secondary mirror combination, positioned in the common optical path to transmit the sample-scattered light from the cell to the spectrometer.

The purpose of the invention is to increase greatly the collection efficiency for scattered light, thereby allowing detection and identification of smaller samples of a material than is otherwise possible, or to allow such detection in a shorter time.

This invention increases collection efficiency by using a cylindrical sample cell that has been coated on its cylindrical surface with a highly reflective specular material, normally aluminum. Not only light that is initially emitted in the direction of the slit contributes to the measurement, but light that is initially emitted in other directions also contributes, resulting in a large (potentially ten-fold) increase.

### BRIEF DESCRIPTION OF THE DRAWINGS

FIG. 1 is a sample cell according to the invention;

FIG. 2 is a sample cell according to the invention;

FIG. 3 is a sample cell according to the invention;

FIG. 4 is a sample cell according to the invention;

FIG. 5 is a sample cell according to the invention;

FIG. 6 is a sample cell according to the invention;

FIG. 7 is a spectroscopy system according to the invention;

FIG. 8 is a spectroscopy system according to the invention; and

FIG. 9 is a spectroscopy system according to the invention.

### DETAILED DESCRIPTION OF THE INVENTION

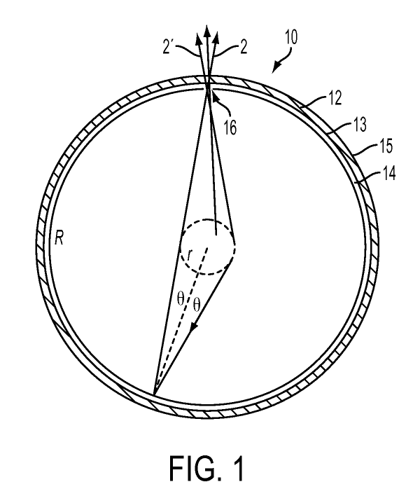

This invention increases collection efficiency by using a cylindrical sample cell 10, shown end-on in FIG. 1, having a transparent wall 12 that has been coated on either the outside surface 13 or surface 15 with a coating 14 of a highly reflective material, normally aluminum, that results in a specularly reflecting (that is, mirror-like) surface. The laser beam is sent through the cell along, or close to, its cylindrical axis 17, so that the scattered light comes from a small axial region. The coating 14 has a narrow rectangular opening or slit 16 at the top which can be mated to the entrance slit of a spectrometer (the opening can be wider than the slit) or matched to the f-number of collection optics that feed the spectrometer, as further described below.

In FIG. 1, the dotted circle of radius r represents the source region, that is, the axial region of the cylinder that is illuminated by the laser or other stimulating source. Within this region rays are emitted isotropically or approximately so. Upon emission, rays either exit through the slit, as shown by example ray 1, or, far more likely, strike the wall of the cylinder. If the cylinder's wall is just glass, these rays (except for a small reflected component) will exit the cylinder and be lost. But if the wall is a specular reflector (a mirror), then some of these rays will be reflected in such a way that they will contribute to light entering the spectrometer. Example ray 2 originates at the edge of the source region and tangent to it. The ray strikes the outer surface of the cylinder and is reflected as shown after which it exits the cylinder. The angle between the ray and the surface normal is θ and the reflected ray is tangent to the circle of radius r. Observe that sin θ=r/R. This tangent ray is shown because the angle between it and the surface normal, θ, is the largest possible: a ray from anywhere else in the source region (or not tangent to the dashed circle) makes a smaller angle with the surface normal.

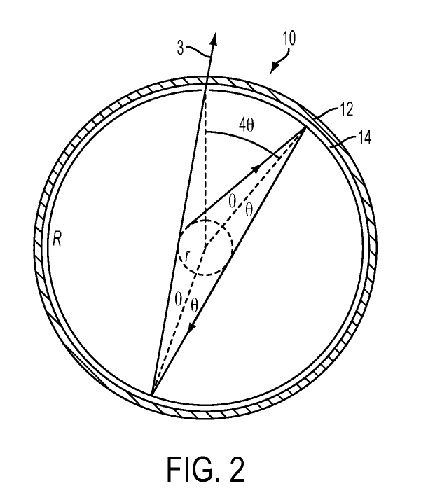

Example ray 2 shows the most basic form of this invention: if the wall of the cylinder opposite the slit is coated with a specularly-reflecting material (normally aluminum), then approximately twice as many rays will enter the spectrometer as otherwise. This principle extends to higher numbers of reflections. In FIG. 2, example ray 3, again chosen tangent to the source region, reflects twice before passing through the slit. At each reflection, the angle between the ray and the surface normal is θ and the reflected ray is always tangent to the circle of radius r. Compared to example ray 2, a different part of the outer wall of the cylinder must be reflective in order for this ray to reach the slit and we see by extension that coating the entire wall of the cylinder will maximize the signal in the spectrometer.

The following remarks apply to rays emitted in the plane of FIG. 1 (the generalization to all rays will be done later). If r<<R, the fraction of rays from any point in the source region that, like example ray 1, exit the slit directly is closely approximated by the fraction f=wₛ/πD where wₛ is the width of the slit, D=2R is the diameter of the tube and πD is its circumference. The quantity f can conveniently be referred to as the port fraction of the tube, in analogy to the port fraction of an integrating sphere¹. An equal fraction of the emitted rays behave like example ray 2: they are reflected off the other side of the tube and illuminate the slit just as the initial direct rays did, but are reduced in intensity by the factor ρ, where ρ is the reflectivity of the wall. The same is true of rays like example ray 3 in FIG. 2, which are reduced in intensity by the factor ρ², and so on. Thus, the intensity of light exiting the slit is increased by, approximately, the factor

$${M}_{1} = 1 + ρ + {ρ}^{2} + … = \frac{1}{1 - ρ} . \qquad ( 1 )$$

For aluminum, we generally find ρ≧0.85 for wavelengths greater than 200 nm, so we expect M₁ to be at least about 7.

The reason why Eq. (1) is an approximation is explained in the next paragraph. Observe that rays always exit the slit within the angle 2θ, while the acceptance angle of the spectrometer is 2 tan⁻²(1/2F)≈1/F, where F is the spectrometer's f-number. In order not to waste signal, the condition 2θ≦1/F should be met, that is, r/R should not be too large. Also, the diameter of the tube should be as small as possible to make the port fraction f=wₛ/πD as large as possible. This is because a small port fraction requires a large number of reflections before all the light exits, and some light is lost at each reflection.

Eq. (1) is an approximation for the following reason. Observe that the angle subtended by the slit at the center of the cylinder is θₛ=wₛ/R. The first condition of validity of Eq. (1) is that 4θ be at least as large as θₛ. If this is not true, then second- and third-reflection rays will not fully illuminate the slit (only direct and first-reflection rays will). The second condition of validity is that the port fraction be small. At some point the light from the nth reflection doesn't fully illuminate the slit because, while an nth-reflection ray may exit the center of the slit, its close neighbor that would illuminate the edge of the slit has already exited at an earlier reflection. The smaller the port fraction, the more this point is postponed and the more nearly valid is Eq. (1), that is, the more effective at collecting light and sending it into the spectrometer the cell will be. [The knowledgeable reader will recognize Eq. (1) as the “sphere multiplier” of an integrating sphere for the case of a negligibly small port fraction¹.]

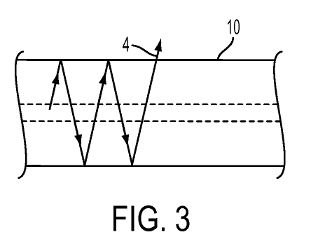

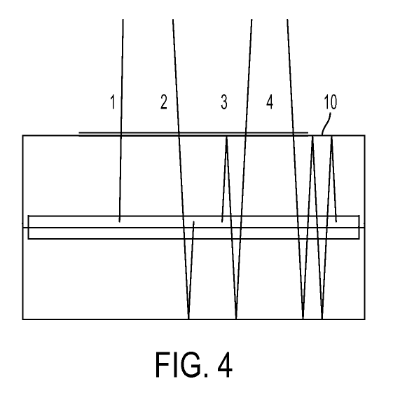

Generalizing to all rays is done by observing that none of the foregoing comments will change if the rays in FIGS. 1 and 2 have a component of direction parallel to the axis of the tube. As shown in FIG. 3, that component of direction does not change upon reflection. If the angle between example ray 4 and the vertical axis of FIG. 3 does not exceed 1/2F it will be accepted by the spectrometer if passes through the slit. FIG. 4 shows examples of rays similar to those in FIGS. 1 and 2, but having horizontal components of motion. Observe that only ray 1 would exit the slit if the cylinder were not coated with a reflective material. Note that ray 4 originates outside the region of the slit but exits through it. For this reason, the length of the source region should exceed the length of the slit. Because of the assumption that the liquid is optically thin, increasing the length of the source region does not decrease the intensity of the laser beam (only reflections do).

If the tube were coated with a diffusive reflecting material, as is done with an integrating sphere, then the increase in flux exiting the slit would be the same but, with reference to FIG. 1, the flux, instead of being restricted to angles between rays 2 and 2′ and therefore accepted by the spectrometer, would be spread out over the entire range of angles from −90 deg to +90 deg, which means that less would enter the spectrometer. This is the fundamental reason why the specular integrator outperforms the diffusive integrator in this application.

The invention works best if the entire wall of the cylinder (except for the slit) is coated, but, as can be seen in FIG. 1, coating only part of the wall can increase the signal: if the bottom part of the wall is coated so that single-reflection rays, such as example ray 2, illuminate the slit, then signal can be approximately doubled. Coating only part of the wall is technically easier than coating the entire wall, and can still lead to a significant signal increase.

The coating can be applied to either the outside or the inside of the cylinder's surface. The former is technically easier, but, depending on the application, the latter may be necessary in order for the beam to be reflected by the coating material itself, without passing through the glass wall of the cylinder before (and after) the reflection. These remarks also apply to coatings on the ends of the cylinder, described below.

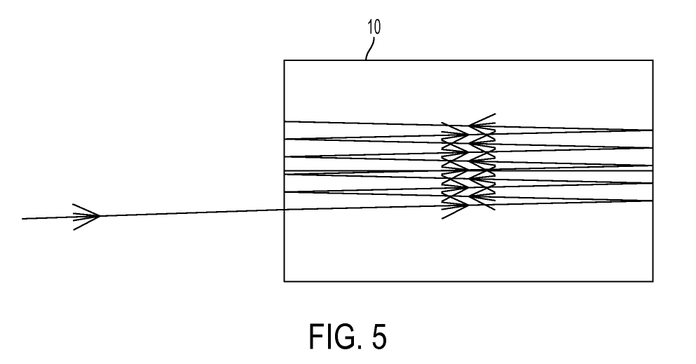

The mirror-like inner or outer wall can be combined with other features to increase signal enhancement further. The signal originates from a laser beam that is sent into the cylinder along its axis and can therefore be increased by increasing the amount of light passing through the region. This may be done by increasing the power of the beam, which may be neither cheap nor easy, or by passing the beam through this region many times. This can be done by coating parts of the ends of the cylinder with the same (or similar) material that is used on the cylindrical surface. As indicated in FIG. 5, this is done in such a way that the beam enters the cell on the left, through an uncoated part of the end of the cylinder, then is reflected back and forth through the cell multiple times, each time striking a portion of a cylinder end that has been coated. For best results, this must be done in such a way that as many as possible of the reflected beams remain within the axial source region of FIG. 1 and this requires careful alignment of the beam: the off-normal angle with which the beam enters the end of the cylinder must be as small as possible, while still allowing the beam to be almost completely in the uncoated region when it enters the cell and almost completely in the coated region at the second reflection. The less well this condition can be satisfied, the fewer reflections of the beam will remain inside the desired central region.

At each reflection, the beam's intensity is reduce by the factor ρ. The signal enhancement to be expected from N reflections is therefore

$${M}_{2} = 1 + ρ + {ρ}^{2} + … + {ρ}^{N} = \frac{1 - {ρ}^{N}}{1 - ρ} . \qquad ( 2 )$$

Using ρ=0.9 as a representative value, we note that 0.9¹⁰=0.39 while 0.9²⁰=0.12, which shows that the number of reflections within the central region needs to be fairly large for best results.

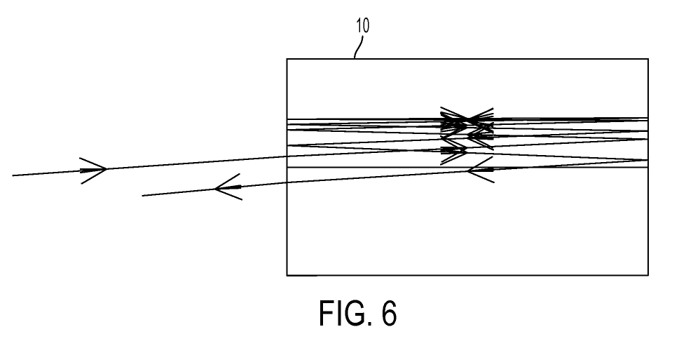

As indicated above, the efficacy of the multiple reflections is at least somewhat limited by the difficulty of keeping the beam within the desired central region. This difficulty can be alleviated by slightly tilting the right end of the cell, as shown in FIG. 6. When this is done, the beam, instead of continuously “walking” upward as it reflects between the ends of the cylinder, as in FIG. 5, first walks upward but then slows down and reverses direction. This makes it easier to keep the beam within the desired central region. As shown in FIG. 6, the right end of the cylinder is tilted about an axis perpendicular to the page, with the consequence that the beam returns to the uncoated region and may thereby exit the cylinder. But observe from FIG. 6 that the points at which the reflected beam strike the left end of the cylinder may be separated somewhat from the point at which the beam enters the cylinder, which means that the reflected beam may not exit the cylinder if the uncoated region is small and the beam is angled just right when it enters the cell. This problem can be alleviated if the right end of the cylinder is tilted slightly about the figure's vertical axis so that the beam is deviated slightly into or out of the page. Along with a properly limited uncoated region, this assures that the reflected beam will not return to the uncoated region (and exit the cell prematurely).

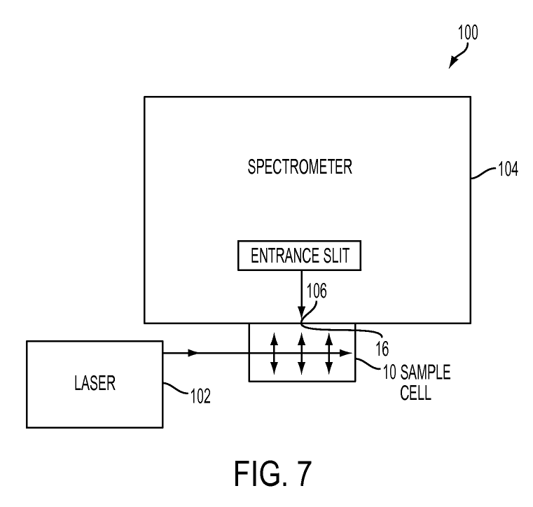

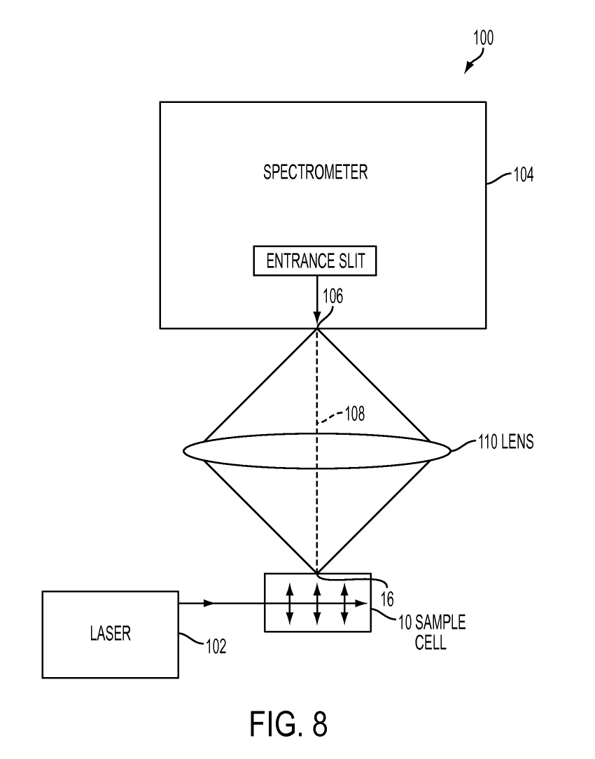

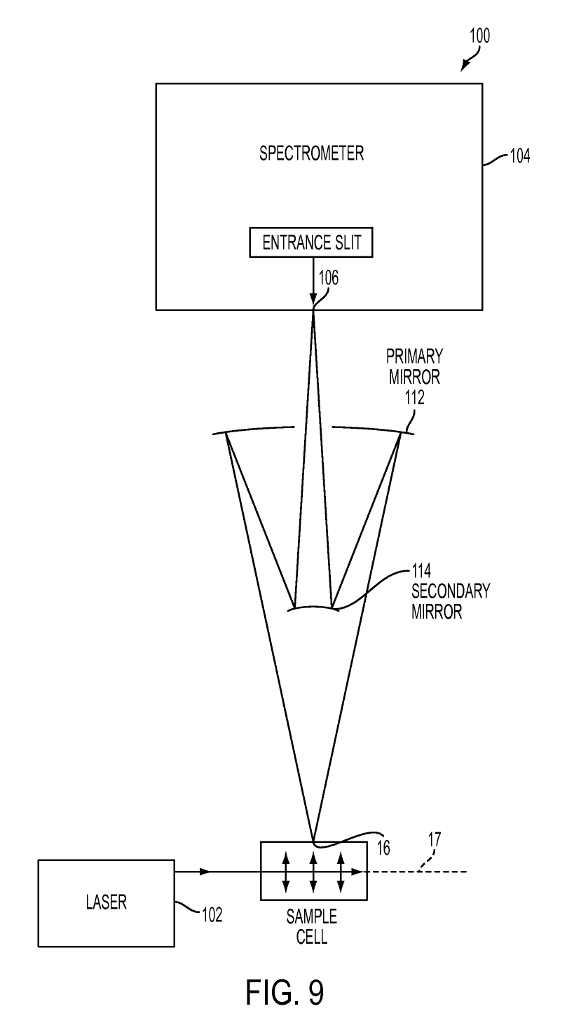

In one embodiment, a spectroscopy system 100 includes a laser light source 102, sample cell 10, and a spectrometer 104 having an aperture 106 aligned with slit 16 of sample cell 10 along a common optical focal axis or path 108. A laser beam stimulates the liquid in sample cell 10. Light is Raman-scattered or re-emitted in all directions by the material in the cell, as described above. Raman-scattered light exiting slit 16 along path 108 enters aperture 106 of spectrometer 104, either directly as shown in FIG. 7 or via a light collection optics means such as a lens 110 positioned in path 108 as shown in FIG. 8. An alternative light collection optics means is shown in FIG. 9, where Raman-scattered light exiting slit 16 is reflected by a primary mirror 112 onto a secondary mirror 114 positioned so as to re-reflect it to aperture 106.

While the present invention has been described with respect to exemplary embodiments thereof, it will be understood by those of ordinary skill in the art that variations and modifications can be effected within the scope and spirit of the invention.

What is claimed as new and desired to be protected by Letters Patent of the United States is:

1. A scattered-light spectroscopy system for collecting light scattered from a sample and producing a spectrum of the sample, comprising:
a spectrometer including an aperture for receiving the light scattered from the sample;
a cylindrical cell for holding the sample and having a central axis, comprising:
a transparent wall having an inside surface and outside surface;
a reflective coating on the inside surface or the outside surface; and
an opening in the reflective coating aligned with the aperture along a common optical path; and
a light source positioned such that light illuminates the sample to produce a scattered light having a first portion received directly at the opening and a second portion reflected by the reflective coating one or more times prior to traversing the opening and the common optical path and thereby adding to the first portion of scattered light entering the aperture of the spectrometer, thereby improving a collection efficiency of the spectrometer.

2. The spectroscopy system of claim 1, wherein the light is a laser beam transmitted along the axis and the scattered light is Raman-scattered.

3. The spectroscopy system of claim 2, wherein the reflective coating comprises aluminum.

4. The spectroscopy system of claim 1, wherein the reflective coating covers substantially all of the inside surface or the outside surface.

5. The spectroscopy system of claim 4, wherein the reflective coating comprises aluminum.

6. A scattered-light spectroscopy system for collecting light scattered from a sample and producing a spectrum of the sample, comprising:
a spectrometer including an aperture for receiving the light scattered from the sample;
a cylindrical cell for holding the sample and having a central axis, comprising:
a transparent wall having an inside surface an outside surface;
a reflective coating on the inside surface or the outside surface; and
an opening in the reflective coating aligned with the aperture along a common optical path;
a light source positioned such that light illuminates the sample to produce a scattered light having a first portion received directly at the opening and a second portion reflected by the reflective coating one or more times prior to traversing the opening and the common optical path and thereby adding to the first portion of scattered light entering the aperture of the spectrometer, thereby improving a collection efficiency of the spectrometer; and
a light collection optics means positioned in the common optical path for receiving and transmitting the first and second Raman-scattered light portions from the cell opening to the aperture of the spectrometer.

7. The spectroscopy system of claim 6, wherein the light collection optics means is a lens.

8. The spectroscopy system of claim 6, wherein the light collection optics means comprises a primary mirror and a secondary mirror.

9. The spectroscopy system of claim 6, wherein the light is a laser beam transmitted along the axis and the scattered light is Raman-scattered.

10. The spectroscopy system of claim 9, wherein the reflective coating comprises aluminum.

11. The spectroscopy system of claim 10, wherein the reflective coating covers substantially all of the inside surface or the outside surface.

12. The spectroscopy system of claim 6, wherein the reflective coating covers substantially all of the inside surface or the outside surface.

13. The spectroscopy system of claim 12, wherein the reflective coating comprises aluminum.

14. A cylindrical cell for holding a sample while exposing the sample to a light source for producing a spectrum of the sample, comprising:
a transparent wall having an inside surface an outside surface;
a reflective coating on the inside surface or the outside surface; and
an opening in the reflective coating alignable with an aperture in a spectrometer for receiving sample-scattered light.

15. The cell of claim 14, wherein the reflective coating comprises aluminum.

16. The cell of claim 15, wherein the reflective coating covers substantially all of the inside surface or the outside surface.
